(19) United States
(12) Patent Application Publication
(10) Pub. No.: US 2026/0266402 A1
(43) Pub. Date: Sep. 10, 2026

(54) IMPROVEMENTS IN OR RELATING TO FLEXIBLE DUCTS

(71) Applicant: BFM TECHNOLOGY LIMITED, Auckland (NZ)

(72) Inventor: Blair Forres MCPHEAT, Auckland (NZ)

(73) Assignee: BFM TECHNOLOGY LIMITED, Auckland (NZ)

(21) Appl. No.: 19/661,442

(22) Filed: Apr. 28, 2026

Related U.S. Application Data
(63) Continuation of application No. PCT/IB2025/051743, filed on Feb. 19, 2025.

(51) Int. Cl. F16L 11/12

(52) U.S. Cl. CPC F16L 11/122

(57) ABSTRACT

A flexible duct able to be removably inserted to partially nest into a rigid tube that has an annular channel. The flexible duct comprises of a cylindrical flexible plastic film to convey flowable matter. An injection moulded cuff is provided at an end of the cylindrical plastic film that is over-moulded to the flexible film and that is over-moulded to a resilient band that is held captive by the flexible plastic film and/or the injection moulded cuff. The cuff has an annular rib that can nests in the annular channel. The cuff and resilient band are able to inwardly collapsible to facilitate insertion to and removal of the rib from the rigid tube.

### CROSS-REFERENCE TO RELATED APPLICATION

This application is a continuation of International Application No. PCT/IB2025/051743 filed on Feb. 19, 2025, the entire disclosure of which is incorporated herein by reference for all purposes.

### FIELD

The present invention relates to improvements in or relating to flexible ducts.

### BACKGROUND

Flexible ducts are used in many applications but in particular as an example in the food processing industry. The use of flexible ducts may be desirable where two pieces of plant move or vibrate relative to each other yet material from one piece needs to be conveyed to the other. A flexible duct can accommodate relative motion between the two pieces of plant.

The materials that the ducts help to transport can cause wear on the ducts. In addition, the vibrations can also cause wear of the ducts. The ducts may hence need replacing at intervals. This can be time consuming to do.

In addition, the interface between the plant and a duct needs to be well sealed to ensure that the materials being transported do not escape to ambient. This may be undesirable. So is the induction of matter ambient into the duct. The interface between the plant and the duct may not always be sufficient to prevent such escape especially where the material is transported in a pressurised flowpath and/or where the material is liquid for example.

It may be an object of the present invention to provide a flexible duct that overcomes or at least partially ameliorates some of the abovementioned disadvantages or which at least provides the public with a useful choice.

It may be an object of the present invention to provide a system to transfer flowable material that overcomes or at least partially ameliorates some of the abovementioned disadvantages or which at least provides the public with a useful choice.

It may be an object of the present invention to provide a method of creating a flexible duct that overcomes or at least partially ameliorates some of the abovementioned disadvantages or which at least provides the public with a useful choice.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purposes of this specification, the term “plastic” shall be construed to mean a general term for a wide range of synthetic or semisynthetic polymerization products, and generally consisting of a hydrocarbon-based polymer.

For the purpose of this specification, where method steps are described in sequence, the sequence does not necessarily mean that the steps are to be chronologically ordered in that sequence, unless there is no other logical manner of interpreting the sequence.

### SUMMARY

In a first aspect the present invention may be said to broadly consist in a flexible duct able to be removably inserted to partially nest into a less flexible or rigid tube that has a primary duct adjacent a tube end provided with an annular channel preferably as part of an annularly profiled set out and via the tube flowable matter can be transported into or out of the flexible duct, the flexible duct comprising:
a ducting body of a flexible plastic film to confine and allow the captive conveying of flowable matter to or from the rigid tube through the flexible duct, an injection moulded cuff of a material at an end region of the ducting body that is over-moulded to the flexible film of the ducting body to be integrally connected with the flexible plastic film and that is over-moulded to a resilient band that is held captive by the flexible plastic film and/or the injection moulded cuff, the cuff having at least one annular rib that when inserted to the rigid tube nests in the annular channel, the cuff and resilient band being resilient so as to be inwardly collapsible to facilitate insertion to and removal of the rib from the rigid tube and with sufficient return bias to or towards a more relaxed condition such that the rib between a rib to channel engagement holds the duct against axial separation from the rigid tube.

In a second aspect the present invention may be said to be a flexible duct that removably inserts to a rigid tube that has a tube end provided with an annularly profiled set out and via the tube flowable matter can be transported into or out of the flexible duct, the flexible duct comprising:
a ducting body of a flexible plastic film to confine and allow the captive conveying of flowable matter to or from the rigid tube through the flexible duct, an injection moulded cuff or an elastomeric material at an end region of the ducting body that is over-moulded to the flexible plastic film of the ducting body to be integrally connected with the flexible plastic film and that is over-moulded to a resilient band that is held captive by the flexible plastic film and/or the injection moulded cuff, each of the cuff and the annularly profiled set out having at least one annular rib directed to the annular rib of each other, and at least one of the cuff and the annularly profiled set out having two of the ribs so as to have the rib of the cuff and the annularly profiled set out are engagingly flanked by the two ribs of the other of the cuff and the annularly profiled set out, the cuff and resilient band being resilient so as to be inwardly collapsible to facilitate insertion and removal of the cuff from the rigid tube into the set out and with sufficient return bias to or towards a more relaxed condition such that the tube rib between a two rib engagement holds the duct against axial separation from the rigid tube.

In a further aspect the present invention may be said to be an assembly as part of a flowable matter transportation system comprising:
a. a rigid tube that has a primary duct adjacent a tube end provided with an annularly profiled set out, and
b. a flexible duct that removably inserts to partially nest into the rigid tube at the set out and via the duct flowable matter can be transported to and/or from the rigid tube, the flexible duct comprising a ducting body of a flexible plastic film to confine and allow the captive conveying of flowable matter to and/or from the rigid tube through the flexible duct, an injection moulded cuff of an elastomeric material at an end region of the ducting body that is over-moulded to the flexible plastic film of the ducting body to be integrally connected with the flexible plastic film and that is over-moulded to a resilient band that is held captive by the flexible plastic film and/or the injection moulded cuff,
wherein the cuff has at least one annular rib that when inserted to the rigid tube nests in an annular channel of the annularly profiled set out, the cuff and resilient band being resilient so as to be inwardly collapsible to facilitate insertion and removal of the cuff from the rigid tube into the set out and with sufficient return bias to or towards a more relaxed condition such that a rib to channel engagement holds the duct against axial separation from the rigid tube.

In yet a further aspect the present invention may be said to be a system that can be assembled to provide for transport of flowable material and can then be disassembled, comprising:
a. a first rigid tube that has a primary duct adjacent a tube end provided with an annularly profiled set out,
b. a second rigid tube that has a primary duct adjacent an end region provided with an annularly profiled set out,
c. a flexible duct comprising a ducting body of a flexible plastic film to confine and allow the captive conveying of flowable matter from the first rigid tube through the flexible duct to the second rigid tube, the flexible tube having a first end region at where the flexible tube removably inserts to partially nest into the first flexible duct at its set out and a second end region at where the flexible tube removably inserts to partially nest into the first flexible duct at its set out,
wherein at each of the first end region and second end region an injection moulded cuff of an elastomeric material is provided to the ducting body that is over-moulded to the flexible plastic film of the ducting body to be integrally connected with the flexible plastic film and that is over-moulded to a resilient band that is held captive by the flexible plastic film and/or the injection moulded cuff, and
wherein at each of the first end region and second end region the cuff has at least one annular rib that when inserted to it respective rigid tube nests in an annular channel of the annularly profiled set out to the annular rib of each other, the cuff and resilient band being resilient so as to be inwardly collapsible to facilitate insertion and removal of the cuff from its respective rigid tube into the set out and with sufficient return bias to or towards a more relaxed condition such that the rib to channel engagement holds the duct against axial separation from the both rigid tubes.

In still a further aspect the present invention may be said to be a tubular flexible connector to duct particulate material from a rigid discharge tube to a rigid receiving tube, the flexible connector comprising:
a duct of a flexible plastic film material that has at least one end region that comprises a resiliently banded cuff of an injection moulded material over moulded to the plastic film material and defining an external profile comprising at least one rib adapted to each mate, after a return from a distorted form of the cuff, in a complementary internal channel of at least one of the discharge tube and the receiving tube, the cuff being resilient so as to be deformable inwardly of a notional tube axis of the connector thereof to facilitate insertion or removal of the coupling at the channel and with sufficient return bias to or towards a more relaxed condition such that the rib to channel engagement holds the connector to the discharge or receiving tube to which it is connected.

Preferably the band is cylindrical in shape.

Preferably the band is formed from strip or flat of metal.

Preferably the band is captive inside the elastomeric material.

Preferably the band is captive between the elastomeric material and the flexible plastic film.

Preferably the band is not exposed to external of the flexible duct.

Preferably the flexible plastic film has a distal end that extends to the end of the duct at the cuff.

Preferably the flexible plastic film has a distal end that extends to the end of the duct annularly interior of the cuff.

Preferably the cuff has a distal end that extends to the end of the flexible plastic film.

Preferably the distal end of the cuff and the distal end of the flexible plastic film are contiguous.

Preferably the ducting body at the end region has the cuff and/or the plastic film inwardly of the cuff, present a surface to abut a surface of the less flexible or rigid tube.

Preferably the ducting body at the end region has the cuff and/or the plastic film inwardly of the cuff, present a surface to abut a complimentary surface of the less flexible or rigid tube.

Preferably the ducting body at the end region has the cuff and/or the plastic film inwardly of the cuff, present a flat surface to abut a flat surface of the less flexible or rigid tube.

Preferably the ducting body has a cylindrical interior that at the end region has the cuff and/or the plastic film inwardly of the cuff, present a flat surface at 90 degrees to the surface of the cylindrical interior, to abut a flat surface of the less flexible or rigid tube.

Preferably the ducting body has a cylindrical interior that at the end region transitions at a 90 degree corner to a flat surface of the plastic film and/or cuff presented at 90 degrees to the surface of the cylindrical interior, to abut a flat surface of the less flexible or rigid tube.

Preferably the end region is formed by and in a mould.

Preferably the elastomeric material of the cuff is exposed for direct contact with the tube.

Preferably the cuff comprises of two parallel annular ribs spaced axially from each other.

Preferably the cuff comprises of two parallel annular ribs spaced axially from each other intermediate thereof the cuff presenting a annular trough.

Preferably at least one annular nub is presented at the trough projecting radially outwardly.

Preferably at least two parallel annular nubs are presented at the trough projecting radially outwardly.

Preferably at least two parallel and spaced apart annular nubs are presented at the trough projecting radially outwardly.

Preferably 4 spaced apart parallel annular nubs are presented at the trough projecting radially outwardly.

Preferably the cuff comprises of two parallel annular ribs spaced axially from each other and intermediate of the annular peaks of the two ribs there is at least one annular nub projecting radially outwardly.

Preferably the nubs project radially outwardly to press onto a radially inwardly presented ridge of the set out.

Preferably the cuff comprises of two parallel annular ribs that are spaced apart axially to each located in a respective channel of the set out.

Preferably the cuff comprises of two parallel annular ribs that are spaced apart axially to each register at and be pressed into in a respective channel of the set out.

Preferably the cuff, from its distal end in sequence comprises a first annular rib, an annular trough and a second annular rib, the first and second ribs each comprising a respective peak flanking the trough.

Preferably the cuff, from its distal end in sequence comprises a first annular rib, an annular trough, a second annular rib and an annular run out to an inner end of the cuff distal the distal end.

Preferably the run out is a tapered region of the cuff comprising a smaller diameter than the diameter of the rib(s).

Preferably the run out is a tapered region of the cuff comprising a smaller diameter than the diameter of the trough.

Preferably the run out feathers towards the ducting body.

Preferably the tube engaging surfaces of the cuff have a continuously curved profile.

Preferably the cuff comprises of two parallel annular ribs that are spaced apart axially separated by an intermediate trough together of a continuously curved profile.

Preferably the cuff comprises of two parallel annular ribs that are spaced apart axially separated by an intermediate trough together of a continuously curved profile save for at least one annular numb at the intermediate trough.

Preferably the ducting body is comprised of a cylindrical formed sheet of flexible plastic film material defining the internal cylindrical surface of the ducting body.

Preferably the internal cylindrical surface is of the same diameter as the diameter of the primary duct of the tube.

Preferably the notional axis of the internal cylindrical surface is colinear the notional axis of the primary duct of the tube.

Preferably the band is a cylindrical shaped band presented co-axial the cylindrical interior surface of the ducting body

Preferably the band is flanked by two regions of the over moulded cuff a where the cuff is over moulded to the flexible plastic film.

Preferably the cuff is heat welded, by being over moulded, to the plastic film.

Preferably the cuff is heat welded, by being over moulded, to the band.

Preferably the band is not exposed to external of the flexible duct.

Preferably the elastomeric material of the cuff is in immersive contact with the band.

Preferably the band comprises a plurality of aperture therethrough said elastomeric material of the cuff passing through the plurality of apertures.

Preferably the band is cylindrical in shape.

Preferably the band is formed from strip or flat of metal.

Preferably the band is captive inside the elastomeric material.

Preferably the band is captive between the elastomeric material and the flexible plastic film.

Preferably the band is not exposed to external of the flexible duct.

Preferably the flexible plastic film has a distal end that extends to the end of the duct at the cuff.

Preferably the flexible plastic film has a distal end that extends to the end of the duct annularly interior of the cuff.

Preferably the cuff has a distal end that extends to the end of the flexible plastic film.

Preferably the cuff and the distal end of the flexible plastic film are contiguous.

Preferably the ducting body at the end region has the cuff and/or the plastic film inwardly of the cuff, present a surface to abut a surface of the less flexible or rigid tube.

Preferably the ducting body at the end region has the cuff and/or the plastic film inwardly of the cuff, present a surface to abut a complimentary surface of the less flexible or rigid tube.

Preferably the ducting body at the end region has the cuff and/or the plastic film inwardly of the cuff, present a flat surface to abut a flat surface of the less flexible or rigid tube.

Preferably the ducting body has a cylindrical interior that at the end region has the cuff and/or the plastic film inwardly of the cuff, present a flat surface at 90 degrees to the surface of the cylindrical interior, to abut a flat surface of the less flexible or rigid tube.

Preferably the ducting body has a cylindrical interior that at the end region transitions at a 90 degree corner to a flat surface of the plastic film and/or cuff presented at 90 degrees to the surface of the cylindrical interior, to abut a flat surface of the less flexible or rigid tube.

Preferably the end region is formed by and/or in a mould.

Preferably the elastomeric material of the cuff is exposed for direct contact with the tube.

Preferably the cuff comprises of two parallel annular ribs spaced axially from each other.

Preferably the cuff comprises of two parallel annular ribs spaced axially from each other intermediate thereof the cuff presenting an annular trough.

Preferably at least one annular nub is presented at the trough projecting radially outwardly.

Preferably at least two parallel annular nubs are presented at the trough projecting radially outwardly.

Preferably at least two parallel and spaced apart annular nubs are presented at the trough projecting radially outwardly.

Preferably 3 spaced apart parallel annular nubs are presented at the trough projecting radially outwardly.

Preferably the cuff comprises of two parallel annular ribs spaced axially from each other and intermediate of the annular peaks of the two ribs there is at least one annular nub projecting radially outwardly.

Preferably the nubs project radially outwardly to press onto a radially inwardly presented ridge of the set out.

Preferably the cuff comprises of two parallel annular ribs that are spaced apart axially to each located in a respective channel of the set out.

Preferably the cuff comprises of two parallel annular ribs that are spaced apart axially to each register at and be pressed into in a respective channel of the set out.

Preferably the cuff, from its distal end in sequence comprises a first annular rib, an annular trough and a second annular rib, the first and second ribs each comprising a respective peak flanking the trough.

Preferably the cuff, from its distal end in sequence comprises a first annular rib, an annular trough, a second annular rib and an annular run out to an inner end of the cuff distal the distal end.

Preferably the run out is a tapered region of the cuff comprising a smaller diameter than the diameter of the rib(s).

Preferably the run out is a tapered region of the cuff comprising a smaller diameter than the diameter of the trough.

Preferably the run out feathers towards the ducting body.

Preferably the tube engaging surfaces of the cuff have a continuously curved profile.

Preferably the cuff comprises of two parallel annular ribs that are spaced apart axially separated by an intermediate trough together of a continuously curved profile.

Preferably the cuff comprises of two parallel annular ribs that are spaced apart axially separated by an intermediate trough together of a continuously curved profile save for at least one annular numb at the intermediate trough.

Preferably the ducting body is comprised of a cylindrical formed sheet of flexible plastic film material defining the internal cylindrical surface of the ducting body.

Preferably the internal cylindrical surface is of the same diameter as the diameter of the primary duct of the tube.

Preferably the notional axis of the internal cylindrical surface is colinear the notional axis of the primary duct of the tube.

Preferably the band is a cylindrical shaped band presented co-axial the cylindrical interior surface of the ducting body

Preferably the band is flanked by two regions of the over moulded cuff a where the cuff is over moulded to the flexible plastic film.

Preferably the cuff is heat welded, by being over moulded, to the plastic film.

Preferably the cuff is heat welded, by being over moulded, to the band.

Preferably the band is not exposed to external of the flexible duct.

Preferably the elastomeric material of the cuff is in immersive contact with the band.

Preferably the band comprises a plurality of aperture therethrough said elastomeric material of the cuff passing through the plurality of apertures.

Preferably the primary duct has an inner cylindrical surface that is of the same diameter as the internal cylindrical surface of the end region.

Preferably an inner surface of a non-set out region of the tube and an inner surface of the duct are in alignment and are at least substantially flush one with each other.

Preferably an inner surface of a non-set out region transitions to an abutting surface of the tube that is if a profile to abut an end surface of the duct.

Preferably an inner surface of a non-set out region transitions to an abutting surface of the tube that is if a profile to abut an end surface of the duct in a manner so that the inner surface of the non set out region is flush with the inner surface of the duct.

Preferably also provided is a second rigid tube that has a primary duct adjacent a tube end provided with an annularly profiled set out,
wherein the flexible duct can be removably inserted at a second end, region opposed to the first mentioned end region, to partially nest into the second rigid tube at its set out and via the duct flowable matter can be transported from the first mentioned rigid tube to the second rigid tube, at the second end region of the ducting body there is provided a second injection moulded cuff of an elastomeric material is over-moulded to the flexible plastic film of the ducting body to be integrally connected with the flexible plastic film and that is over-moulded to a second resilient band that is held captive by the flexible plastic film and/or the second injection moulded cuff,
wherein the second cuff has at least one annular rib that when inserted to the rigid tube nests in an annular channel of the annularly profiled set out of the second rigid tube, the second cuff and resilient band being resilient so as to be inwardly collapsible to facilitate insertion and removal of the second cuff from the second rigid tube into the set out and with sufficient return bias to or towards a more relaxed condition such that a rib to channel engagement holds the duct against axial separation from the second rigid tube.

Preferably the second tube has a primary duct with a notional axis that is colinear the notional axis of the primary duct of the first mentioned tube.

Preferably the or each cuff has two parallel annular ribs and the first tube has two parallel complementary channels that each conform to a corresponding one of the annular ribs of the cuff and which connect via the channels of the first tube.

Preferably the two ribs are part of the cuff.

Preferably the duct is a connector.

Preferably the set out of the tube has a roll formed construction.

Preferably the cuff has two parallel annular ribs and the tube has two parallel complementary channels that each conform to a corresponding one of the annular ribs of the cuff and which connect via the rib of the tube.

Preferably the tube includes in sequence toward its distal end:
the primary duct, the end region having an outwardly directed annular channel set out from the primary duct.

Preferably the tube includes in sequence toward its distal end:
the primary duct, the tube end having an outwardly directed first annular channel set out from the primary duct, a ridge set inwardly more than first annular channel and outwardly directed second annular rib set out more than the ridge and the primary duct.

Preferably the tube includes in sequence toward its distal end:
the primary duct, the end region having an outwardly directed first annular channel set out from the primary duct, a ridge set inwardly more than first annular channel and outwardly directed second annular rib set out more than the ridge and the primary duct and inwardly directed annular lip that is closest to an end of the tube to which the duct is fit.

Preferably the lip present the free distal end of the tube.

Preferably the lip is of a decreasing diameter as it progresses from the second channel to the free distal end of the tube.

Preferably each of the cuff and the annularly profiled set out comprise of at least one annular rib directed to the annular rib of each other, and at least one of the cuff and the annularly profiled set out comprise of two of the ribs so as to have the rib of the cuff and the annularly profiled set out engagingly flanked by the two ribs of the other of the cuff and the annularly profiled set out.

Preferably the cuff is resiliently deformable inwardly of a tube axis thereof to facilitate insertion or removal of the flexible duct from the tube and with sufficient return bias to or towards a more relaxed condition such that the rib between a two rib engagement holds the flexible duct and the tube against axial separation from each other.

Preferably the cuff has two parallel annular ribs and the tube has two parallel complementary channels that each conform to a corresponding one of the annular ribs of the cuff and which connect via the rib of the flexible duct.

In a further aspect the present invention may be said to be a flexible coupling as herein described releasably connected to and between two spaced part tubes that each comprise of a primary duct adjacent an end region of the tube that comprises at least one set out annular channel into which a rib of the cuff of the coupling can register and nest to hold the duct against axial separation from the rigid tube.

Preferably two ribs are part of the cuff.

Preferably the flowable matter comprises gas.

Preferably the flowable matter comprises gas and particulate matter.

Preferably the flowable matter comprises gas entrained or carried particulate matter.

Preferably the flowable fluid matter comprises liquid.

In a further aspect the present invention may be said to be a method of creating a flexible duct as herein described wherein a flowable material to define the cuff is injected into a mould that contains the resilient band and the end region of the flexible plastic film to flood the cavity with said flowable material to over mould the flowable material to the resilient band and the flexible plastic film in-situ.

In a further aspect the present invention may be said to be a method of creating a flexible duct as herein described a flowable material to define the cuff is injected into a mould that contains the resilient band and the end region of the flexible plastic film to flood the cavity with said flowable material to over mould the flowable material to the resilient band and the flexible plastic film simultaneously.

In a further aspect the present invention may be said to be a flexible duct as herein described having been produced using the method as herein described.

In yet a further aspect the present invention may be said to be an injection moulded cuff has been formed in a mould with the end region and resilient band in situ.

In a further aspect the present invention may be said to be a flexible duct able to be removably inserted to partially nest into a rigid tube that has an annular channel.

Preferably the flexible duct comprises of a cylindrical flexible plastic film to convey flowable matter.

Preferably an injection moulded cuff is provided at an end of the cylindrical plastic film that is over-moulded to the flexible film and that is over-moulded to a resilient band that is held captive by the flexible plastic film and/or the injection moulded cuff.

Preferably the cuff has an annular rib that can nests in the annular channel.

Preferably the cuff and resilient band are able to inwardly collapsible to facilitate insertion to and removal of the rib from the rigid tube.

Preferably the resilient band is cylindrical in shape and has a first edge and a second edge and a cylindrical wall that extends between the first edge and second edge, and wherein the cylindrical wall extends longitudinally to be proud of the annularly profiled set out that the cuff is or is to be registered with, on the side of the cuff most distal from the end region of the ducting body.

Preferably, by being presented in said proud manner, the resilient band is able to be manually pressed by a person.

Preferably, by being presented in said proud manner, the snap band is able to be directly manually depressed by a person to deform the cuff when the cuff is registered at a respective set out.

Preferably, wherein by being presented in said proud manner, the resilient band is able to be manually depressed by a person to deform the cuff when the cuff is registered at a respective set out without the prepressing force being applied directly only to the flexible plastic film.

Preferably, wherein: a) the first edge of the resilient band is located inwardly of the set out when in use when the cuff is registered with a respective set out, and b) the second edge of the snap band is located outwardly of the set out and a longitudinal distance away from the set out when in use when the cuff is registered with a respective set out.

Preferably wherein, by being presented in said proud manner, the resilient band is able to be directly manually depressed by a person to deform the cuff when the cuff is registered at a respective set out without the prepressing force being applied directly only to the flexible plastic film.

Preferably, wherein, the flexible plastic film radially underlies both the resilient band and the profiled ring at said cuff and wherein resilient band longitudinally spans from (a) where the flexible plastic film underlies the resilient band and the resilient band underlies the profiled ring to (b) where the flexible plastic film underlies the resilient band and not the profiled ring.

Preferably wherein, the flexible plastic film radially underlies both the resilient band and the profiled ring at said set out and wherein resilient band longitudinally spans from (a) where the flexible plastic film underlies the resilient band and the resilient band underlies the set out to (b) where the flexible plastic film underlies the resilient band and not the set out.

Preferably wherein first edge of the resilient band is located inwardly of the profiled ring and the second edge of the resilient band is located outwardly of the profiled ring and in use when the cuff is registered with a respective set out is presented a longitudinal distance away from the set out.

Preferably, the longitudinal distance is at least 5 mm.

Preferably, the longitudinal distance is at least 6 mm.

Preferably, the longitudinal distance is at least 8 mm.

Preferably, the longitudinal distance is at least 10 mm.

Preferably, the longitudinal distance is at least 15 mm.

Preferably, the longitudinal distance is at least 20 mm.

Preferably, the longitudinal distance is at least 25 mm.

Preferably, the longitudinal distance is at least 30 mm.

Preferably, the longitudinal distance is at least 35 mm.

Preferably, the longitudinal distance is at least 40 mm.

Preferably, the longitudinal distance is no greater than 40 mm.

Preferably, the longitudinal distance is no greater than 30 mm.

Preferably, the longitudinal distance is no greater than 20 mm. wherein the longitudinal distance is between 5 mm and 40 mm.

Preferably, the flexible plastic film radially underlies both the resilient band and the profiled ring at said set out and wherein resilient band longitudinally spans from (a) where the flexible plastic film underlies the resilient band and the resilient band underlies the set out to (b) where the flexible plastic film underlies the resilient band and not the set out.

Preferably, the cylindrical wall extends longitudinally from its underlying condition adjacent the profiled ring to be proud of the profiled ring on the side of the profiled ring most proximate the other of said inlet cuff and outlet cuff.

Preferably, the cylindrical wall extends longitudinally from its underlying condition adjacent the profiled ring to be proud of the complimentary profiled set out that the cuff is or is to be registered with, on the side of the profiled ring most proximate the other of said inlet cuff and outlet cuff.

Preferably, the flexible duct comprises a radially outward profiled ring overlaying the resilient band, the radially profiled ring able to be deformed to be releasably registered radially inwardly to a complimentary profiled part of the set out and when so registered creates an interface with the tube that prevents said flowable matter from escaping the flexible duct via the interface and securely holds the flexible duct to the tube.

Preferably, the cylindrical wall extends longitudinally to be proud of the radially outward profiled ring on the side of the cuff most distal from the end region of the ducting body.

In a further aspect, there is provided a flexible duct able to be removably inserted to partially nest into a less flexible or rigid tube that has a primary duct adjacent a tube end provided with an annularly profiled set out and via the tube flowable matter can be transported into or out of the flexible duct. The flexible duct comprises a ducting body of a flexible plastic film to confine and allow the captive conveying of flowable matter to or from the tube through the flexible duct, a cuff of an elastomeric material at an end region of the ducting body; a resilient band that is held captive by the flexible plastic film and/or the cuff, the cuff comprising of at least one annular rib that, when inserted into the tube, nests in an annular channel of the annularly profiled set out, the cuff and resilient band being resilient so as to be inwardly collapsible to facilitate insertion to and removal of the cuff from the tube at the annularly profiled set out and with return bias to or towards a more relaxed condition such that at the set out and between a rib to channel engagement the rigid tube holds the duct against axial separation from the rigid tube; wherein the resilient band is cylindrical in shape and has a first edge and a second edge and a cylindrical wall that extends between the first edge and second edge, and wherein the cylindrical wall extends longitudinally to be proud of the annularly profiled set out that the cuff is or is to be registered with, on the side of the cuff most distal from the end region of the ducting body.

Preferably, by being presented in said proud manner, the resilient band is able to be manually depressed by a person to deform the cuff when the cuff is registered at a respective set out.

Preferably, by being presented in said proud manner, the resilient band is able to be manually depressed by a person to deform the cuff when the cuff is registered at a respective set out without the prepressing force being applied directly only to the cylindrical wall.

Preferably, a) the first edge of the resilient band is located inwardly of the set out when in use when the cuff is registered with a respective set out, and b) the second edge of the snap band is located outwardly of the set out and a longitudinal distance away from the set out when in use when the cuff is registered with a respective set out, wherein the longitudinal distance is between 5 mm and 40 mm.

Preferably, the longitudinal distance is between 10 mm and 20 mm.

Preferably, the flexible duct comprising a radially outward profiled ring overlaying the resilient band, the radially profiled ring able to be deformed to be releasably registered radially inwardly to a complimentary profiled part of the set out and when so registered creates an interface with the tube that prevents said flowable matter from escaping the flexible duct via the interface and securely holds the flexible duct to the tube.

Preferably, the cylindrical wall extends longitudinally to be proud of the radially outward profiled ring on the side of the cuff most distal from the end region of the ducting body.

In a further aspect there is provided a flexible duct able to be removably inserted to partially nest into a less flexible or rigid tube that has a primary duct adjacent a tube end provided with an annularly profiled set out and via the tube flowable matter can be transported into or out of the flexible duct. The flexible duct comprises a ducting body of a flexible plastic film to confine and allow the captive conveying of flowable matter to or from the tube through the flexible duct, a cuff of an elastomeric material at an end region of the ducting body; the cuff having a profile that, when inserted into the tube, nests in a complementary annularly profiled set out; the cuff comprising a radially outward profiled ring able to be deformed; the cuff and ring being resilient so as to be inwardly collapsible to facilitate insertion to and removal of the cuff from the tube at the annularly profiled set out and with return bias to or towards a more relaxed condition to be releasably registered radially inwardly to a complimentary profiled part of the set out and when so registered creates an interface with the tube that prevents said flowable matter from escaping the flexible duct via the interface and securely holds the flexible duct to the tube.

Preferably, the flexible duct comprising a resilient band that is held captive by the flexible plastic film and/or the cuff.

Preferably, the resilient band is cylindrical in shape and has a first edge and a second edge and a cylindrical wall that extends between the first edge and second edge, and wherein the cylindrical wall extends longitudinally to be proud of the annularly profiled set out that the cuff is or is to be registered with, on the side of the cuff most distal from the end region of the ducting body.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

### BRIEF DESCRIPTION OF THE DRAWINGS

The invention will now be described by way of example only and with reference to the drawings in which:

FIG. 1: is a perspective view of a flexible duct,

FIG. 2: is a perspective view of the flexible duct in the process of being connected or disconnected from a rigid tube,

FIG. 3: is a perspective and cut-away view of a flexible duct and rigid tube,

FIG. 4: is a partial view of the end region of a rigid tube,

FIG. 5: is a perspective view of a rigid tube,

FIG. 6: is a partial sectional view of the rigid tube of FIG. 5,

FIG. 7: is a side view of a flexible duct and rigid tube in a separated yet aligned condition,

FIG. 8: is a sectional view of a close-up of part of FIG. 7,

FIG. 9a: is a cross-sectional view of the interface of a flexible duct and rigid tube,

FIG. 9b: is a variation of the cross-sectional view of the interface of a flexible duct and rigid tube,

FIG. 10: is a close-up sectional view of the interface of a flexible duct at the opposite end of the duct to that of FIG. 9,

FIG. 11: is a cross-sectional view of the end region of the flexible duct in cross-sectional view,

FIG. 12: is a variation of the end region of the flexible duct shown in cross-sectional view,

FIG. 13A: is yet a further variation of the end region of a flexible duct in cross-sectional view,

FIG. 13B: is yet a further variation of the end region of a flexible duct in cross-sectional view

FIG. 14: illustrates the interface between a flexible duct at its end region and a rigid tube, shown in cross-sectional view,

FIG. 15: illustrates a variation of the interface between a flexible duct at its end region and a rigid tube, shown in cross-sectional view,

FIG. 16: is a variation of the interface between the flexible duct and rigid tube,

FIG. 17: is a close-up sectional view of part of a flexible duct and rigid tube connected together,

FIG. 18: is a variation of the interface,

FIG. 19: shows a further variation of the configuration at the end region of a flexible duct, shown at cross sectional view,

FIG. 20: shows a further variation,

FIG. 21: is a partial sectional view of a flexible duct according to another embodiment;

FIG. 22: is a cross-sectional view of a rigid tube according to the other embodiment;

FIG. 23: is a partial cross the interface of the flexible duct of FIG. 21 and the rigid tube of FIG. 22,

FIG. 24: is a perspective view of the flexible duct of FIG. 21 partially engaged with the rigid tube of FIG. 22,

FIG. 25: is a partial cut-away view of the flexible duct of FIG. 21 engaged with the rigid tube of FIG. 22,

FIG. 26: is a close-up sectional view of the interface of the flexible duct and the rigid tube of FIGS. 24 and 25,

FIG. 27: is a partial view of a variation of the flexible duct of the embodiment of FIG. 21,

FIG. 28: is a partial sectional view of the flexible duct of FIG. 27,

FIG. 29: is a partial view of a variation of the rigid tube of the embodiment of FIG. 22,

FIG. 30: is a partial sectional view of the rigid tube of FIG. 29.

### DETAILED DESCRIPTION

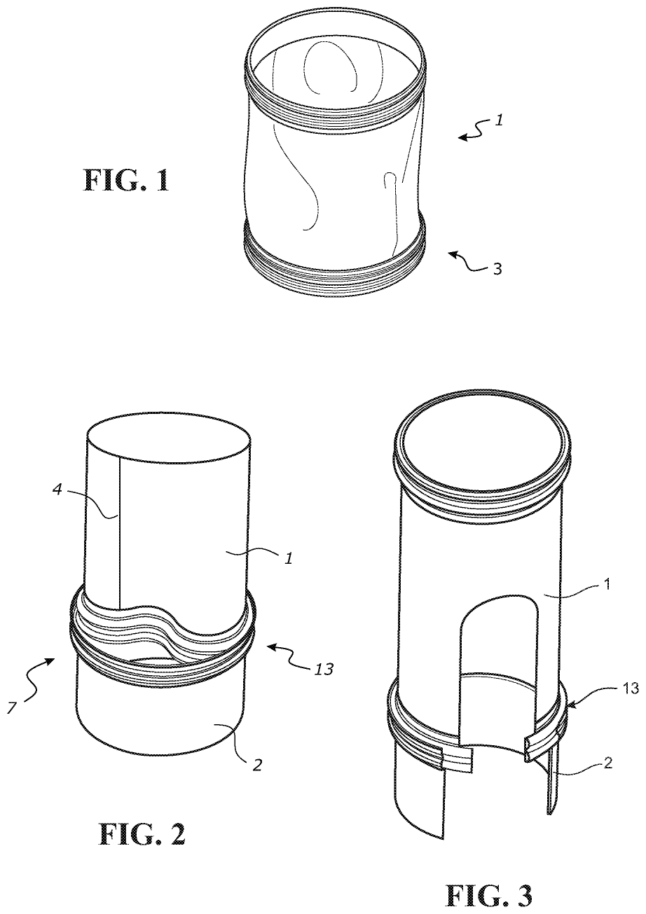

With reference to the accompanying figures there is shown in FIG. 1 an example of flexible duct 1. The flexible duct may facilitate the conveying a flowable matter from an entry of the duct to another location. The entry is preferably an entry opening. Preferably the other location is an exit of the duct. The exit may be an exit opening or may be more than one exit openings. The duct may define at least one flow passage for the flowable material although it is envisaged that the flexible duct may include a partition that made allow for at least partially separated flow paths to be established within the flexible duct. Such flow paths may be in co or counter directional. The flexible duct may for example also be used as part of a filtration system where a filter is incorporated to the flexible duct such that there is no discrete single outlet of the flexible duct but where gas flow passes through the filter and particulate matter is caught by the filter.

The flexible duct 1 is able to cooperate with a rigid tube 2. The flexible duct 1 is able to connect with the rigid tube 2 is a releasable manner. When connected, the flexible duct and the rigid tube are interfaced such that it provides a leak proof interface. It may be sufficiently leakproof to prevent particulate matter from passing through the interface and preferably also to prevent liquid matter from passing through the interface.

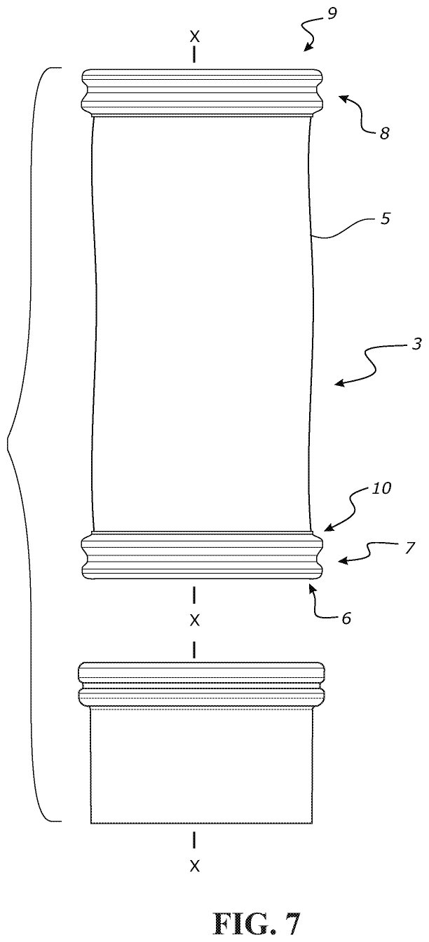

Reference will first herein be made to the flexible duct. As seen FIGS. 1 and 7, the flexible duct 1 comprises of a ducting body 3, the ducting body is preferably of a flexible film or sheet preferably comprising a plastic material that may for example be thermoplastic such as a polyurethane. It may be an ether based polyurethane alloy. It may be an assembly of plies of flexible film or sheet material. For example there may be a primary ply of polyurethane and an internal scrim of polyester. The plies are preferably laminated to each other.

The ducting body 3 is preferably made from a sheet of flexible plastic film that is formed into a tubular configuration and that may be welded to itself at a seam weld 4.

This may a lapped weld or a butt weld. In some forms its envisaged that the ducting body may be extruded and not hence have a seam.

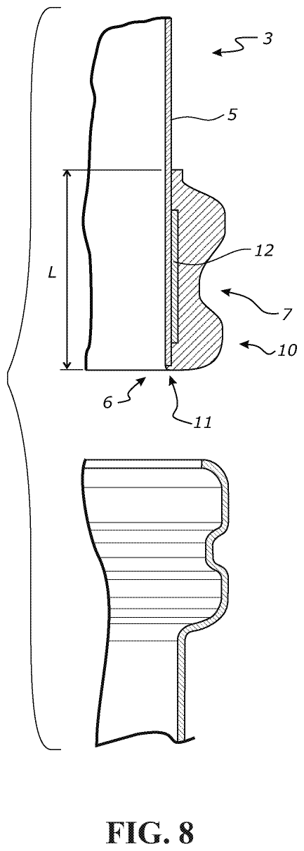

As seen in FIGS. 7 and 8, the flexible plastic film 5 preferably extends all the way to the distal end 6 at an end region 7 of the ducting body. The flexible duct 1 preferably has a first end region 7 and a second end region 8 as seen for example in FIG. 7.

The plastic film 5 preferably extends all the way from the first distal end 6 of the ducting body 3 to the second distal end 9 of the ducting body. In a preferred form the flexible duct may be in the form of a connector and is provided for the passage of flowable matter to or from the rigid tube 2, to another location. In some forms the other location may be a second rigid tube that is connected at the opposite end of the flexible duct. However, in alternative configurations the flexible duct may be provided for other purposes such as for filtration as described above or where the duct may act as a funnel or hopper for discharging flowable material into a bag or elsewhere without there being a rigid tube connected at both ends of the duct and only at one end.

The ducting body 3 is able to confine and allow the captive conveying of flowable matter to or from the rigid tube 2 through the flexible duct. The rigid tube 2 may be part of a processing plant (for example at a food processing facility). The rigid tube (and/or the component that may be attached to the other end of the flexible duct) may be subject to vibration. The flexible nature of the flexible duct may be required to make the connection between two such plant components.

At least at a first end region 7 of the flexible duct there is provided a cuff. The cuff 10 is of an injection moulded material preferably of a rubber or elastomeric material. The material may for example be silicone or polyurethane. If of PU it is preferably softer than the PU of the flexible plastic film. The injection moulded cuff is provided at the end region 7 of the ducting body 3. The cuff is injection moulded to the ducting body in an over moulded manner. The moulded cuff is formed using injection moulding tooling to be formed and simultaneously be bonded to the flexible plastic film of the ducting body by way of over moulding.

It can be seen that at the interface 11 of the cuff and the plastic film, the cuff is bonded to the plastic film by virtue of having been injection moulded in situ to the plastic film. The cuff extends partially axially along and outside of the ducting body and has features that will herein after be described.

The over moulded injection moulded cuff, by being moulded in-situ to about the plastic film of the ducting body, insures that at the interface 11 the cuff and the plastic film become integrally connected to each other. The injection moulding involves a pressurised injection of the cuff material in a flowable state, into a mould. The cuff material is preferably at an elevated temperature when injection moulded. It has preferably been heated or caused to heat up. The plastic film, being for example of a thermoplastic plastic material such as polyurethane, ensures that when the hot and flowable precursor of the cuff material is injection moulded, being of a higher temperature than when it has set, will cause for a welded interface at the interface 11 to be established between the cuff and the flexible plastic tube. This will facilitate the establishing of an integral bond so that the cuff and the ducting body become integrally to each other. To enhance bonding between the cuff and ducting body, the surface of the ducting body to interface with the cuff can treated. This may be by such surface being scuffed or roughened. This may be done by an abrasive blasting or friction step that treats the surface.

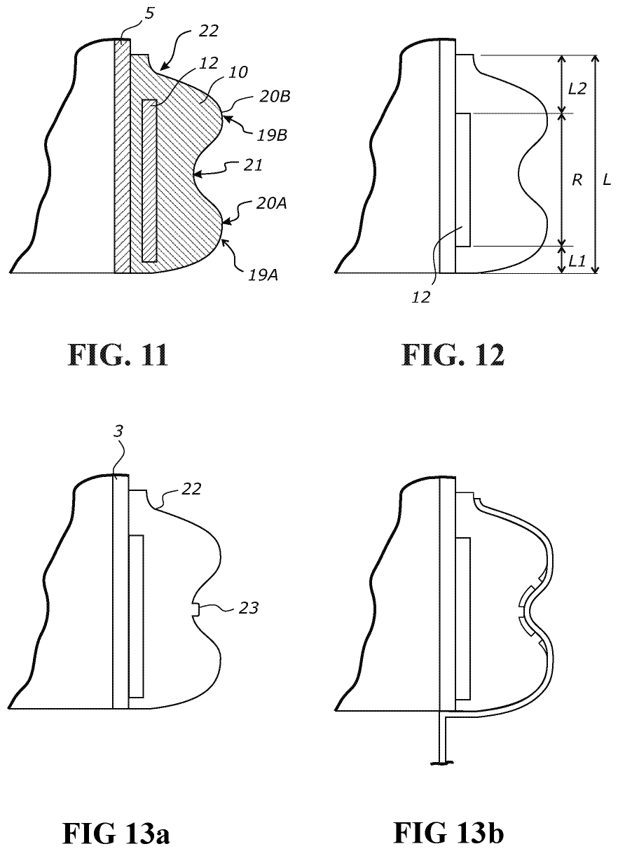

At the first end region 7 of the ducting body 3 there is also provided a resilient band 12. The resilient band 12 is held captive by the flexible plastic film and/or the injection moulded cuff 10. In the example as seen in FIG. 8, the resilient band is located intermediate of the flexible plastic film 5 and the cuff 10 whereas in FIG. 11 it can be seen that the flexible resilient band 12 is enveloped entirely within the cuff 10.

In the preferred form the resilient band 12 is held captive between the plastic film 5 and the injection moulded cuff 10. The resilient band 12 is also over moulded by the injection moulded cuff 10. The injection moulded cuff 10 is hence moulded with the resilient band in-situ with the flexible plastic film 5. Preferably the overmoulding of the cuff with the film and the resilient band happens simultaneously. The mould used defines a cavity for the cuff material that includes the film and the band pre-loaded at the cavity so that when the cuff material is injected it floods the cavity and over moulds to the resilient band and film.

The resilient band may be of a metal material. The resilient band may for example be of stainless steel. The resilient band is preferably of a cylindrical shape having a wall that extends substantially parallel to the tube axis XX. The resilient band may be made from a strip of metal material that is seam welded to define its cylindrical form.

By being over moulded by the injection moulded cuff the resilient band is held captive and enveloped within the other materials at the end region 7 of the flexible duct. In a preferred form no parts of the resilient band are exposed to external of the flexible duct.

The wall length R of the band 12 is preferably less than the length L of the cuff in the tube axis direction. In a preferred form the resilient band has a wall length R that is shorter than the length L so that at the end regions of the length L of the cuff, the cuff has some length (L 1 and L 2) at where the cuff is able to make contact with the flexible plastic film to ensure its bonding the two film. The wall length R of the resilient band 12 is preferably less than the length L. The band's wall length R is preferably still more than half of the length L.

The resilient band 12 is able to be flexibly deformed inwardly towards the tube axis X as for example illustrated in FIG. 2. This can be achieved by a person pushing with their thumb for example at any part of the radius of the duct near the resilient band (eg adjacent the tube end 13). The resilient band in its natural state defines a substantially tubular form of the end region of the flexible duct. This is a more relaxed state whereas in a collapsed state as in FIG. 2 the resilient band is less relaxed.

The resilient band 12 is biased towards its more relaxed state but is able to be deformed inwardly towards the tube axis to allow for the configuration of the end region 7 to be changed and allow for its insertion into the tube end 13 as will hereinafter be described.

The resilient band 12 hence biases the cuff 10 to its natural relaxed state which is a state where the cuff is inserted into a tube end 13 of the rigid tube to establish a sealing interface therewith.

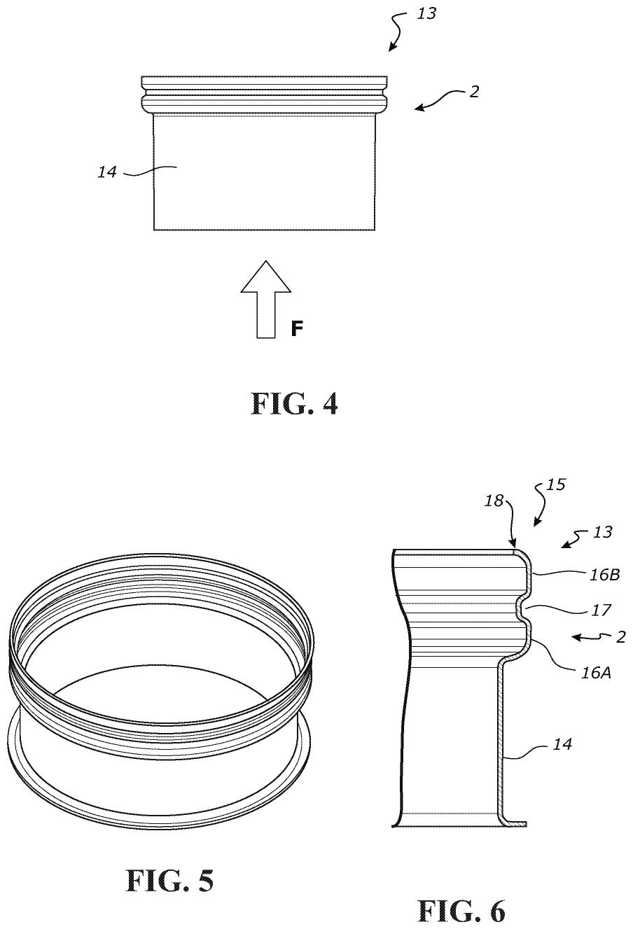

The ability for the resilient band together with the cuff to inwardly collapse helps facilitate the insertion and removal of the cuff from the rigid tube. The rigid tube 2 as seen in FIGS. 4-6 for example comprises of primary duct 14 that is able to duct material in the direction F or in the opposite direction F there through.

In a preferred from the resilient band extends to a location so that it is proud of the tube end 13 as seen in FIG. 3. The distance that it is proud, helps during the removal of the connector from the duct. This is because a person pushing on the connector adjacent the duct then will have their push force applied aligned with the proud portion of the band, making it easier to actuate band for collapse.

The rigid tube 2 is preferably of a metal material. It has a tube end 13 adjacent to the primary duct that is preferably provided with an annularly profiled set out 15. The annularly profiled set out is preferably integrally formed with the primary duct and may for example be formed by a roll forming of a primary duct to define the annularly profiled set out. In a preferred form, the diameter of the annularly profiled set out is at least in part larger than the diameter of the primary duct.

The annularly profiled set out preferably defines at least one channel. It preferably also defines at least one ridge. In the example as seen in FIG. 6 the annularly profiled set out 15 comprises of a first channel 16A. The first channel 16A is preferably formed contiguous the end of the primary duct 14. The annularly profiled set out preferably also includes a second channel 16B. Intermediate of the two channels is a ridge 17. The ridge (which may like the rib(s) of the cuff, be considered a tube rib) defines a part of the annularly profiled set out that is of a smaller diameter than the first and second channels. The first and second channels may be of an identical profile or may be of a different profile to each other. On the opposite side of the second channel 16B to the ridge 17 is an inwardly directed annular lip 18 that defines the distal free end of the tube. The lip is of a decreasing diameter as it progresses from the second channel 16B to the free distal end of the tube. Each of the profiled regions of the annularly profiled set out 15 are of an annular configuration as seen in FIG. 5. The inward facing surface or surfaces of the annularly profiled set out are presented for engagement with the cuff of the flexible duct so as to create a sealed interface there between.

Turning back to the flexible duct, and with reference to for example FIG. 11, the cuff 10 make comprise of a first annular rib 19A and a second annular rib 19B. Each of the annular ribs may have a peak 20A and 20B respectively, an intermediate of which the cuff defines a trough 21. Towards the end of the cuff distal to the first distal end of the ducting body 6, the cuff defines an annular run out region 22.

The run out is a tapered region of the cuff comprising a smaller diameter than the diameter of the ribs. This is where the cuff reduces in diameter towards the external diameter of the ducting body. This preferably is a gradual taper although as seen in FIG. 20 the runouts 22 may include a step or other form. The taper will preferably extend proud of the tube end 13.

In FIGS. 19 and 20 an alternative form of the cuff and the associated annularly profiled set out of the rigid tube are shown as examples. For example where only a single channel is provided by the rigid tube and a single rib is provided by the cuff.

Once registered at the annularly profiled set out and with the resilient band is in its more relaxed (not caved in) state with the cuff captured within the annularly profiled set out, the rib/channel/trough/ridge interface ensures that the flexible duct is axially retained to the rigid tube. Separation in the axial direction parallel to the tube axis XX is prevented by virtue of the cuff being registered at the annularly profiled set out.

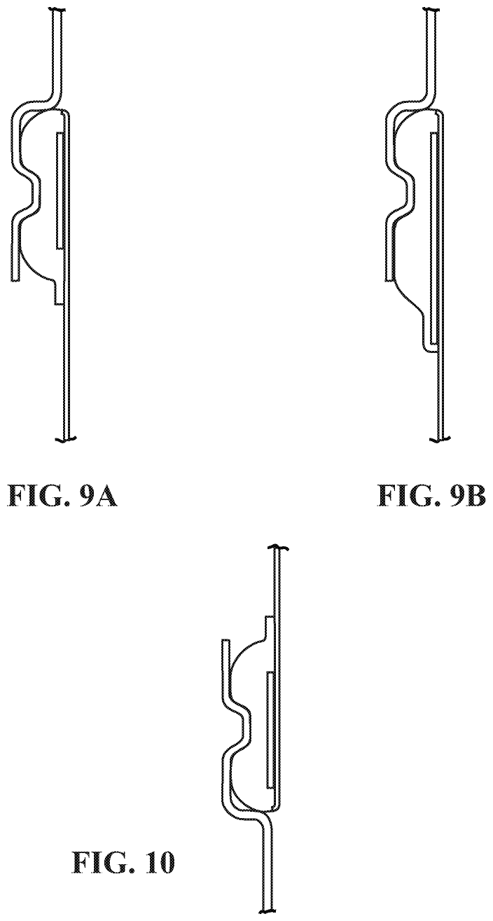

The inwardly facing surfaces of the annularly profiled set out are complimentary to the externally directed surface or surfaces of the cuff. As seen in FIGS. 9a and 10 the surfaces need not be identical to be perfectly matched, as there may be some gaps or cavities between the inwardly and outwardly directed surfaces of the annularly profiled set out and cuff respectively.

FIG. 9b illustrates a variation of cross-sectional view of the interface of a flexible duct and rigid tube of FIG. 9a. In this variation, the resistance band in the injection moulded cuff sits proud of the tube end. This enables easier manual access to the resistance band, for example via a user's finger and/or thumb, in order to more easily disconnect the flexible duct from the rigid tube and/or to more easily facilitate registering of the cuff of the flexible duct with the set out of the rigid tube.

In order to facilitate a sealing interface between the cuff and the rigid tube, the inwardly directed surfaces and outwardly directed surfaces are profiled to facilitate such. A primary sealing interface is established at the trough/ridge interface. Preferably at this interface a primary seal is established between the flexible duct and the tube. The seal is preferably sufficient to prevent the leaking of at least particulate matter and preferably also liquid or fluid matter from the passage of such matter through interface of the tube and flexible duct.

In order to help establish and/or improve the sealing capacity, the profile of the trough of the cuff may include at least one annular nub 23 as seen in FIG. 13. The nub is an annular nub integrally formed with the material of rest of the cuff and is provided to provide a localised annular point of contact between the cuff and the ridge of the rigid tube. The nub is preferably formed with cuff during injection moulding of the cuff. In FIG. 13B a nub that is bullnose in shape is shown. Alternative shapes may include a wedge shape or triangular shape of the nub.

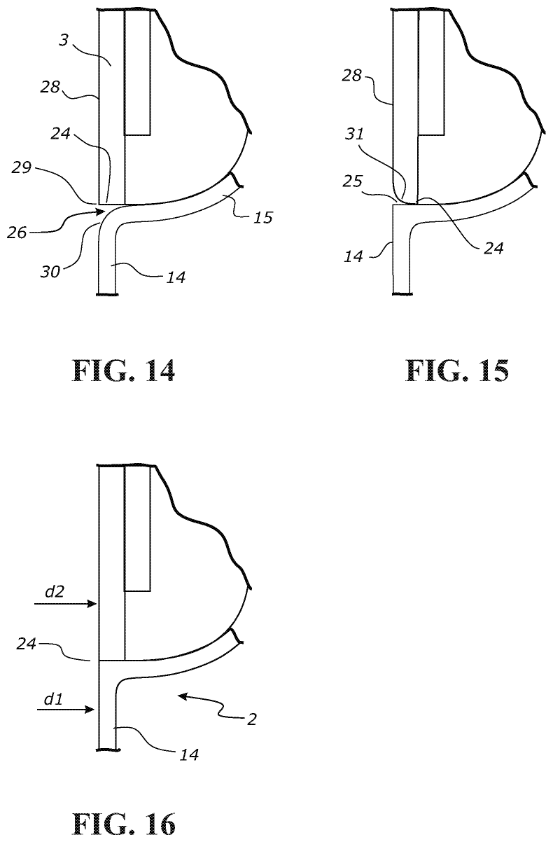

The localised contact provided by the nub can allow, through the appropriate adoption of a shape and configuration of the ridge and trough with its nub, a greater application of pressure thereat between the nub and the ridge. Such greater application of pressure provides a greater capacity to provide sealing between the cuff and the rigid tube. In the example shown in FIG. 14, the cuff may be provided with a plurality of nubs such as three nubs. In a preferred form at least one nub is provided. The nubs are preferably of a round or bull nose profile rather than of a peaked (such as a saw toothed) profile. The three nubbed variant provides three lines of defense of sealing on the primary seal face and designed to provide liquid type sealing. The primary seal faces establish between the nub and the ridge. Secondary seals may be established between the channels and ribs. In a preferred form the first rib is axially spaced from the second rib and the first channel is axially spaced from the second channel and from on the ridge.

In a preferred form the cuff is made of a homogenous material such as of a rubber or elastomeric material such as a silicone. In a preferred form there are no cavities in the cuff nor are there any cavities between the resilient band and the cuff. In a preferred form there are no cavities between the resilient band and the flexible plastic film. In a preferred form there are no cavities between the cuff and the flexible plastic film.

The exterior surface of the cuff is defined by the material from which it is injection moulded. Preferably there is no part of the flexible plastic film that extends over the outwardly facing surfaces of the cuff.

By being injection moulded, the outwardly directed surface or surfaces of the cuff are able to be accurately formed and defined. This provides for an ability to design the shape of the outwardly directed surfaces to be appropriately complimentary to the inwardly directed surfaces of the annularly profiled set out. Such a complimentary shape may be a matching shape or an at least in part matching shape.

Furthermore, in order to prevent entrapment or build-up of matter being transferred through the flexible duct and the rigid tube it is possible for the end region 7 of the flexible duct to be of a shape and configuration to reduce such. In the example seen in FIG. 16 for example the internal diameter d1 of the primary duct 14 of the rigid tube 2 is preferably the same as the diameter d2 of the ducting body 3. The inner surface of the duct is flush with the inner surface of the tube. At the interface 24 of the surfaces the end of the primary duct 14 is preferably of a complementary shape to the end of the ducting body/cuff. The shape may be such as to define an end surface of the primary duct 14 that is substantially at 90 degrees to the tube axis XX. A complimentary 90-degree end surface of the ducting body and/or cuff will ensure that at the interface 24 there is no crevice or cavity or rebate or recess between the flexible duct and the rigid tube as seen in FIG. 16. The rigid tube may be so formed and/or machined to provide a desirable end surface with which the end surface of the flexible duct at its inner diameter is able to mate. The end surface 24/25 of the flexible duct and rigid tube can hence avoid or reduce the prospect of particulate matter from being trapped at any such crevice. Alternative configurations are shown in FIGS. 14 and 15 where a small crevice 26 still exists but is of a smaller and potentially insignificant size. In FIG. 14, the end surface 24 of the ducting body 3 is at 90 degrees to the inner wall 28 of the ducting body and defines a sharp 90-degree corner 29 therebetween. The primary duct 14 in this example may transition to the annularly profiled set out 15 in a radii 30 manner instead. The inverse is shown in FIG. 15 where a sharp corner between the primary duct and the end region 25 of the primary duct is defined yet a radii 31 transition exists from the interior wall 28 of the ducting body to its end region 24.

In a preferred form the second end region 8 of the flexible duct may have a similar cuffed and resilient banded configuration. The ducting body may be cylindrical between the first and second end regions or may be tapered to define a frustoconical shaped flexible duct. In some forms and applications of the flexible duct it may be described as a connecter.

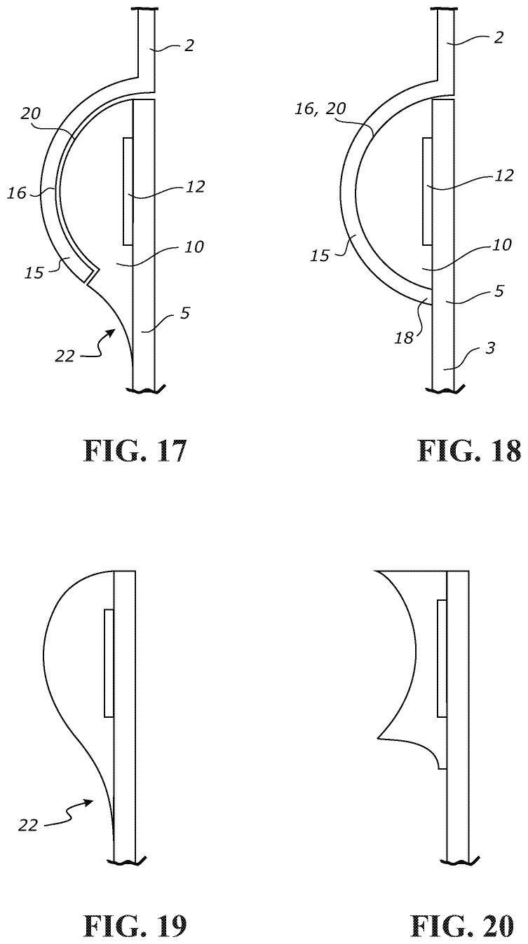

The run out region 22 of the cuff is preferably of a radiused profile so as to help improve drainage. In a plant, particulate matter or liquid may fall down the outside of the flexible duct and it is desirable for such to not pool (or reduce a pooling effect) of such matter. A radiused profile at the run out region that may be exposed beyond the free distal end at the lip 18 of the annularly profiled set up will help reduce the pooling effect. In some embodiments the run out as seen in FIG. 13A may be partly tapered or it may be full tapered so as to transition the cuff and its upwardly directed surface to be substantially parallel and at the same diameter as the outside of the ducting body 3. Such a taper is shown also in FIG. 17. The tapered run out can also help reduce stress concentrations. As the thickness of the cuff reduces at the taper the radial elasticity of the cuff changes. This helps for such elasticity to become more and more commensurate that of the plastic film as the taper thins out.

Alternatively, the annular lip 18 of the annular profile set out 15 may extend to abut in a flushed matter, against the outwardly directed surface of the ducting body 3. This is seen for example in FIG. 18. The injection moulded form of the cuff allows for desirable shape features to be defined of the cuff to provide for the means and the requirements of the use of the flexible duct, in for example food processing plants and the like.

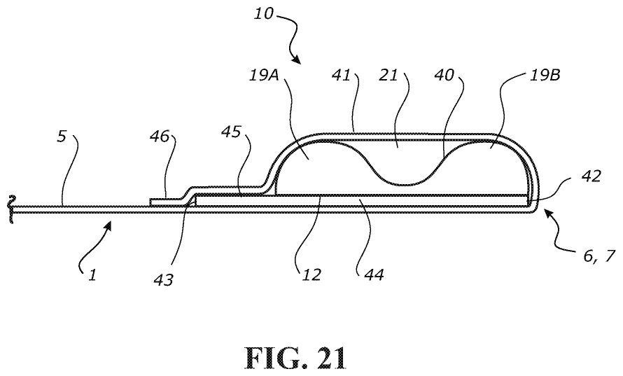

A further variation of a flexible duct and a rigid tube are shown in FIG. 21-23, in which the end region 7 of the flexible duct 1 and the tube end 13 of the rigid tube 2 are illustrated. In this example, the cuff 10 of the flexible duct 1 need not be injection moulded (though it can be and preferably in accordance to, for example, a manner as described above) and may instead be formed in other ways. In one example, the cuff 10 may comprise a separate elastomeric material that is captured by a fold back 41 of the flexible plastic material 5 which is secured using seam welding 46 or some other suitable adhering method. In another example, the cuff 10 may comprise a radially outward profiled ring 40 held captive by the fold back 41.

The radially outward profiled ring 40 may be formed of any suitable resilient but deformable material such as plastics, metals (e.g. stainless steel) or composites. The profiled ring 40 is shape retaining but can be resilient so that it can conform to the shape of a set out 15 when the cuff 10 is retained within a rigid tube 2. Various shapes of profiled ring 40 may be utilised. A double ribbed profiled ring 40 is shown but other profiles are within the scope of the invention that provide for appropriate retention. Examples include those described with respect to FIG. 11-20,

A resilient band 12 underlays the profiled ring 40 and is held captive by the cuff 10 and/or flexible plastic film 5 and extends longitudinally to be proud of the cuff 10 and/or the profiled ring 40 and/or the set out 15 when the cuff is registered with an annularly profiled set out of the rigid tube 2. The longitudinally proud portion 45 facilitates manual disengagement of the flexible duct 1 and rigid tube 2 as described in more detail below.

The resilient band 12 is cylindrical in shape and has a first edge 42 and a second edge 43 and a cylindrical wall 44 that extends between the first edge and the second edge. The cylindrical wall 44 extends longitudinally to be proud of the annularly profiled set out that the cuff is or is to be registered with, on the side of the cuff 10 most distal from the end region 7 of the ducting body 3. The resilient band 12 may be of any suitable material as previously described, including for example rubber, plastics or metal.

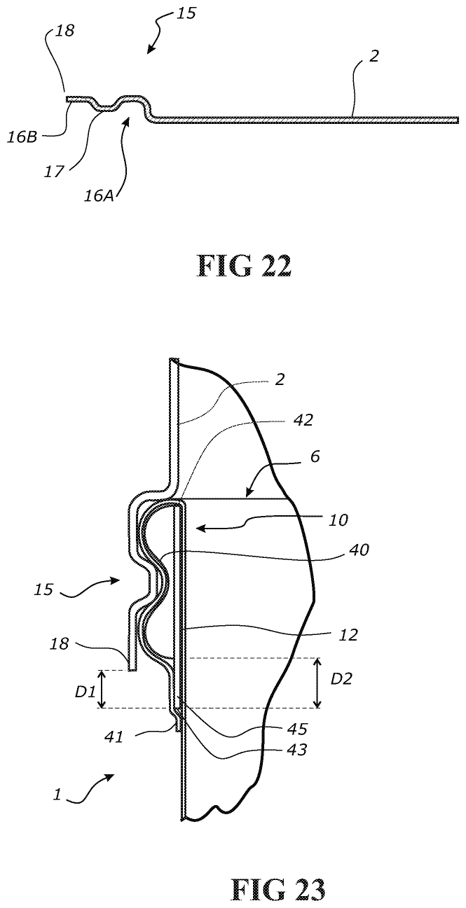

FIG. 22 illustrates a section of the tube end 13 of a rigid tube 2, illustrating the profile of an annularly profiled set out 15. Various profiles may be employed including those previously described with respect to FIG. 11-20. FIG. 23 shows the cuff 10 of FIG. 21 registered with the set out 15 of FIG. 22 to retain the flexible duct 1 within the rigid tube 2.

By being presented in a proud manner, the proud portion 45 of resilient band 12 is able to be manually is able to be manually depressed by a person to deform the cuff when the cuff is registered at a respective set out without the prepressing force being applied directly only to the flexible plastic film. This makes it easier to deform the cuff and disengage the flexible duct 1 from the rigid tube 2. For example, the resilient band 12 may be less flexible than the flexible plastic film 5 that would otherwise be manually depressed and so less manually depressing is required. Use of the proud portion 45 of the resilient band 12 also reduces the risk of stretching or ripping the flexible plastic film 5 which reduces the likelihood of transported matter being spilled and hence the need for clean-up.

The profiled ring 15 may be adhered to the resilient band 12 for example using glue, such that depressing the proud portion of the resilient band 12 causes the profiled ring to also be deformed to allow the flexible duct to be disengaged from the rigid tube. In other examples, the profiled ring may simply be located adjacent the resilient ring, both being captured by the flexible plastic film 5 using the fold back 41 or over moulding for example. By being captured together, deformation of the resilient band 12 by manual pressing also causes deformation of the profiled ring 40.

When the cuff 10 is registered with the set out 15, the resilient band 12 has a second edge 43 that is located at a distance D1 in the longitudinal direction away from the lip 18 of the set out. The other or first edge 42 is located more proximate the proximal inlet or outlet opening of the flexible duct. In a preferred form the span between the first and second edges of the resilient band 12 is greater than the span of the profiled ring 15 so that the second edge 43 is also located as a longitudinal distance beyond the profiled ring 15 in the direction away from the cuff 10 (for example toward another cuff at the other end of the flexible duct 1. The proud region or portion 45 of the resilient band 12 sits proud of the profiled ring 15 and/or the set out 15 a distance that is sufficient for a person's digit (such as the thumb) to be able to directly (albeit via the fold back 41) react onto the resilient band. This distance D1 may be 5 mm or more. It may be around thumb width for example and may be around 10-40 mm in length. The distance D2 at which the resilient band 12 is proud of the profiled ring 15 may be similar or not. The profiled ring 15 may also be proud, to some extent, of the set out 15.

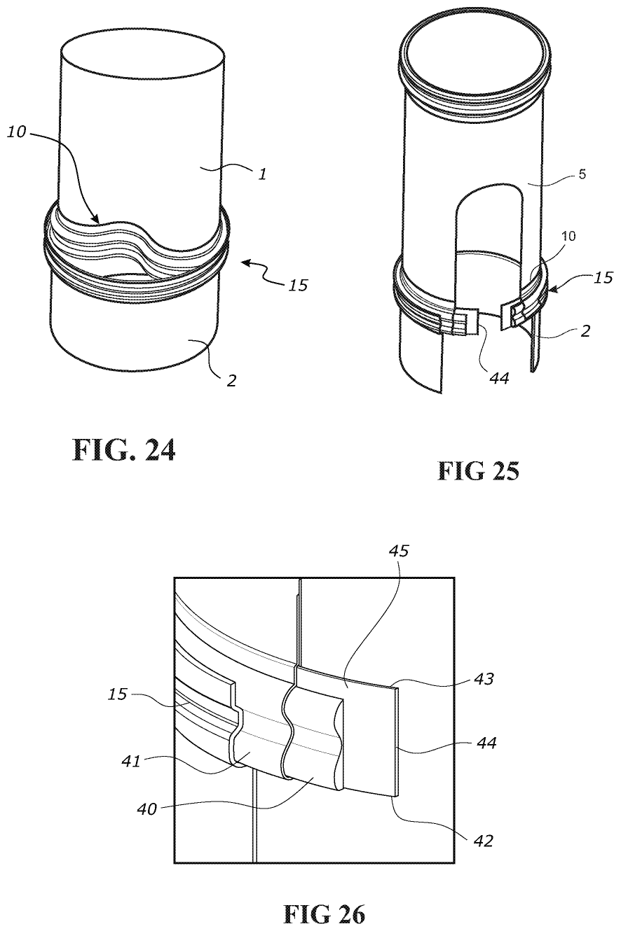

FIGS. 24 to 26 illustrate retention and removal of a flexible duct 1 from a rigid tube 2. FIG. 24 illustrates deformation of the cuff 10 of flexible duct 1 whilst being registered within the set out 15 of the rigid tube 2. Perspective and detailed cut away views in FIGS. 25 and 26 show the profiled ring cylindrical wall 44 and first and second edges 42, 43 of the resilient band 12, the profiled ring 40, fold back 41 and set out 15. The proud portion 45 of the resilient band 12 can also be seen in more detail. It can therefore be seen that pressing inwards on the proud portion 45 of the resilient band will cause deformation of the resilient band 12 as well as the profiled ring 40. This allows the flexible duct 1 to be removed from the rigid tube 2. Similarly, removal of manual depressing of the resilient band 12 will allow both the band 12 and the profiled ring 40 to return to their normal shape to enable the flexible duct 1 to be retained within the rigid tube 2.

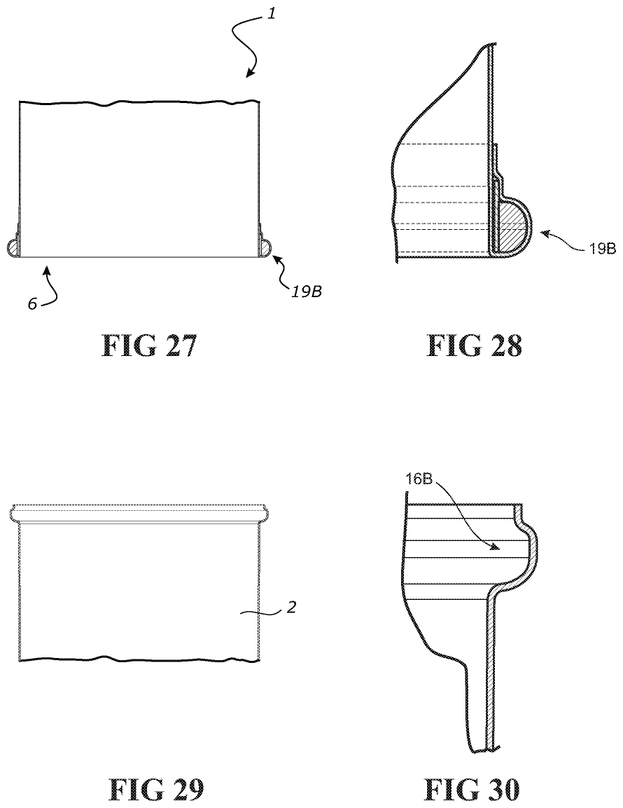

FIGS. 27 to 30 illustrate a variation of the flexible duct 1 in which the cuff 10 comprises a single annular rib 19B and the rigid tube 2 in which the set out 15 comprises a corresponding single channel 16B. Further variations are possible, for example a cuff with a double rib profile may be configured to engage with a set out with a single channel. One or both of the set out 15 and cuff 10 may comprise more than two channels and/or ribs respectively. Further, the shapes of the rib(s) and corresponding channel(s) may be substantially the same or different.

The flexible duct is able to be interchanged quickly from various equipment—for example if a new flexible duct is required to be used because of damage or wear on the previous connector, this can be done easily, quickly and without the need to use tools. The old connector can be snapped out and the replacement can be snapped in.

A person skilled in the art will also appreciate how with the provision of a substantial flushness, there is little in the way of collection areas for particulate materials such as food powders. These should be easily dislodged by regular cleaning without disassembly in conjunction with possible vibrational nature of the structure. Periodic removals of the connector are easy as there is no encircling hose clamp to remove and replace. removal and replacement is simple.

The arrangement as described provides for good hygiene because the design ensures a tight fit, little or no crevices, little or no build up of product and prevents leakage of materials from the bag during filling. Furthermore, the arrangement is less susceptible to damage as no hose clips needed to secure to the equipment and no tools are needed and hence there is no damage as a consequence.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A flexible duct able to be removably inserted to partially nest into a less flexible or rigid tube that has a primary duct adjacent a tube end provided with an annularly profiled set out and via the tube flowable matter can be transported into or out of the flexible duct, the flexible duct comprising:
a ducting body of a flexible plastic film to confine and allow the captive conveying of flowable matter to or from the tube through the flexible duct, an injection moulded cuff of an elastomeric material at an end region of the ducting body that is over-moulded to the flexible plastic film of the ducting body to be integrally connected with the flexible plastic film and that is over-moulded to a resilient band that is held captive by the flexible plastic film and/or the injection moulded cuff, the cuff comprising of at least one annular rib that, when inserted to the tube, nests in an annular channel of the annularly profiled set out, the cuff and resilient band being resilient so as to be inwardly collapsible to facilitate insertion to and removal of the cuff from the tube at the annularly profiled set out and with return bias to or towards a more relaxed condition such that at the set out and between a rib to channel engagement the rigid tube holds the duct against axial separation from the rigid tube.

2. The flexible duct as claimed in claim 1 wherein the band is cylindrical in shape, and wherein the band is formed from strip or flat of metal;
wherein the band is captive inside the elastomeric material of the cuff or wherein the band is captive between the elastomeric material and the flexible plastic film, and wherein the band is not exposed to external of the flexible duct.

3. The flexible duct as claimed in claim 1 wherein the flexible plastic film has a distal end that extends to the end of the duct annularly interior of the cuff.

4. The flexible duct as claimed in claim 1 wherein the ducting body at the end region has the cuff and/or the plastic film inwardly of the cuff, present a surface to abut a complimentary surface of the tube.

5. The flexible duct as claimed in claim 1 wherein the cuff comprises of two parallel annular ribs spaced axially from each other, intermediate thereof the cuff presents at least one annular trough.

6. The flexible duct as claimed in claim 5 wherein at least one annular nub is presented at the trough projecting radially outwardly.

7. The flexible duct as claimed in claim 6 wherein at least two parallel and spaced apart annular nubs are presented at the trough projecting radially outwardly.

8. The flexible duct as claimed in claim 6 wherein the at least one nub projects radially outwardly to press onto a radially inwardly presented ridge of the set out.

9. The flexible duct as claimed in claim 5 wherein the two parallel annular ribs are spaced apart axially to each register at and be pressed against a respective channel of the set out.

10. The flexible duct as claimed in claim 1 wherein the cuff, from its distal end in sequence comprises a first annular rib, an annular trough (with optionally at least one annular nub) and a second annular rib, the first and second ribs each comprising a respective peak flanking the trough.

11. The flexible duct as claimed in claim 1 wherein the cuff, from its distal end in sequence comprises a first annular rib, an annular trough, a second annular rib and an annular run out to an inner end of the cuff distal the distal end.

12. The flexible duct as claimed in claim 11 wherein the run out is a tapered region of the cuff comprising a smaller diameter than the diameter of the rib(s) and/or the peaks or the trough.

13. The flexible duct as claimed claim 1 wherein the tube engaging surfaces of the cuff have a continuously curved profile.

14. The flexible duct as claimed in claim 1 wherein the band is flanked by two regions of the over moulded cuff at where the cuff is over moulded to the flexible plastic film.

15. The flexible duct as claimed in claim 1 wherein the cuff is heat welded, by being over moulded under pressure and heat, to the plastic film or to the band.

16. The flexible duct as claimed in claim 1 wherein the band is not exposed to external of the flexible duct and wherein the elastomeric material of the cuff is in immersive contact with the band.

17. The flexible duct as claimed in claim 1 wherein the band comprises a plurality of apertures therethrough said elastomeric material of the cuff passing through the plurality of apertures.

18. An assembly as part of a flowable matter transportation system comprising:
a rigid tube that has a primary duct adjacent tube end provided with an annularly profiled set out, and
a flexible duct according to any one preceding claim,
wherein the cuff has at least one annular rib that when inserted to the rigid tube nests in an annular channel of the annularly profiled set out, the cuff and resilient band being resilient so as to be inwardly collapsible to facilitate insertion and removal of the cuff from the rigid tube into the set out and with a return bias to or towards a more relaxed condition such that a rib to channel engagement holds the duct against axial separation from the rigid tube.

19. The assembly as claimed in claim 18 wherein an internal cylindrical surface is of the same diameter as the diameter of the primary duct of the tube.

20. The assembly as claimed in claim 18 wherein the notional axis of an internal cylindrical surface is colinear the notional axis of the primary duct of the tube.

21. The assembly as claimed in claim 18 wherein an inner surface of a non-set out region transitions to an abutting surface of the tube that is if a profile to abut an end surface of the duct in a manner so that the inner surface of the non set out region is flush with the inner surface of the duct.

22. The assembly as claimed in claim 18 comprising:
a second rigid tube that has a primary duct adjacent tube end provided with an annularly profiled set out, and
wherein the flexible duct can be removably inserted at a second end region opposed to the first mentioned end region, to partially nest into the second rigid tube at its set out and via the duct flowable matter can be transported from the first mentioned rigid tube to the second rigid tube, at the second end region of the ducting body there is provided a second injection moulded cuff of an elastomeric material is over-moulded to the flexible plastic film of the ducting body to be integrally connected with the flexible plastic film and that is over-moulded to a second resilient band that is held captive by the flexible plastic film and/or the second injection moulded cuff,
wherein the second cuff has at least one annular rib that when inserted to the rigid tube nests in an annular channel of the annularly profiled set out of the second rigid tube, the second cuff and resilient band being resilient so as to be inwardly collapsible to facilitate insertion and removal of the second cuff from the second rigid tube into the set out and with a return bias to or towards a more relaxed condition such that a rib to channel engagement holds the duct against axial separation from the second rigid tube.

23. The assembly as claimed in claim 22 wherein the second tube has a primary duct with a notional axis that is colinear the notional axis of the primary duct of the first mentioned tube.

24. A system that can be assembled to provide for transport of flowable material and can then be disassembled, comprising:
a first rigid tube that has a primary duct adjacent tube end provided with an annularly profiled set out,
a second rigid tube that has a primary duct adjacent an end region provided with an annularly profiled set out,
the flexible duct according to claim 1,
wherein at each of the first end region and second end region the respective cuffs each have at least one annular rib that when inserted to it respective rigid tube nests in an annular channel of the annularly profiled set out of each respective tube, the cuff and resilient band being resilient so as to be inwardly collapsible to facilitate insertion and removal of the cuff from its respective tube into the set out and with sufficient return bias to or towards a more relaxed condition such that the rib to channel engagement holds the duct against axial separation from the both rigid tubes.

25. A tubular flexible connector to duct particulate material from a rigid discharge tube to a rigid receiving tube, the flexible connector comprising:
a duct of a flexible plastic film material that has at least one end region that comprises a resiliently banded cuff of an injection moulded material over moulded to the plastic film material and defining an external profile comprising at least one rib adapted to each mate, after a return from a distorted form of the cuff, in a complementary internal channel of at least one of the discharge tube and the receiving tube, the cuff being resilient so as to be deformable inwardly of a notional tube axis of the connector thereof to facilitate insertion or removal of the coupling at the channel and with a return bias to or towards a more relaxed condition such that the rib to channel engagement holds the connector to the discharge or receiving tube to which it is connected.

26. A method of creating a flexible duct as claimed in claim 1 wherein a flowable material to define the cuff is injected into a mould that contains the resilient band and the end region of the flexible plastic film to flood the cavity with said flowable material to over mould the flowable material to the resilient band and the flexible plastic film in-situ.

27. A method of creating a flexible duct as claimed in claim 1 wherein a flowable material to define the cuff is injected into a mould that contains the resilient band and the end region of the flexible plastic film to flood the cavity with said flowable material to over mould the flowable material to the resilient band and the flexible plastic film in-situ.

28. A method of creating a flexible duct as claimed in claim 1 wherein a flowable material to define the cuff is injected into a mould that contains the resilient band and the end region of the flexible plastic film to flood the cavity with said flowable material to over mould the flowable material to the resilient band and the flexible plastic film simultaneously.

30. The flexible duct as claimed in claim 1 wherein the injection moulded cuff has been formed in a mould with the end region and resilient band in situ.
